(19) United States
(12) Patent Application Publication
(10) Pub. No.: US 2020/0061507 A1
(43) Pub. Date: Feb. 27, 2020

(54) HVAC FILTER FRAME ASSEMBLY

(71) Applicant: Miguel Ceja, Bakersfield, CA (US)

(72) Inventor: Miguel Ceja, Bakersfield, CA (US)

(21) Appl. No.: 16/108,217

(22) Filed: Aug. 22, 2018

(51) Int. Cl. B01D 46/00; B01D 46/10; F24F 13/28

(52) U.S. Cl. CPC B01D 46/0005; F24F 13/28; B01D 46/10; B01D 46/008

(57) ABSTRACT

A HVAC filter frame assembly includes a frame that is positioned in a return air duct of an HVAC system. A pair of rails is each coupled to the frame. A vent is hingedly coupled to the frame and the vent is positionable in between an open position and a closed position. A pair of supports is each hingedly coupled between the frame and the vent. Each of the supports restricts motion of the vent when the vent is opened to retain the vent at a maximum angle with the frame. A filter is positionable between the vent and the rails for filtering air passing through the vent and into the return air duct. The filter is removable when the vent is positioned in the open position. Moreover, each of the supports ranges motion of the vent thereby inhibiting the filter from falling outwardly from the return air duct when the vent is opened. Thus, the filter is inhibited from striking a user when the filter is being changed.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to filter devices and more particularly pertains to a new filter device for inhibiting a filter from falling out of a return air duct when the filter is being changed.

### BRIEF SUMMARY OF THE INVENTION

An embodiment of the disclosure meets the needs presented above by generally comprising a frame that is positioned in a return air duct of an HVAC system. A pair of rails is each coupled to the frame. A vent is hingedly coupled to the frame and the vent is positionable in between an open position and a closed position. A pair of supports is each hingedly coupled between the frame and the vent. Each of the supports restricts motion of the vent when the vent is opened to retain the vent at a maximum angle with the frame. A filter is positionable between the vent and the rails for filtering air passing through the vent and into the return air duct. The filter is removable when the vent is positioned in the open position. Moreover, each of the supports ranges motion of the vent thereby inhibiting the filter from falling outwardly from the return air duct when the vent is opened. Thus, the filter is inhibited from striking a user when the filter is being changed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a HVAC filter frame assembly according to an embodiment of the disclosure.

FIG. 2 is a front phantom view of an embodiment of the disclosure.

FIG. 3 is a top phantom view of an embodiment of the disclosure.

FIG. 4 is a perspective in-use view of an embodiment of the disclosure.

FIG. 5 is a back perspective view of an embodiment of the disclosure.

### DETAILED DESCRIPTION OF THE INVENTION

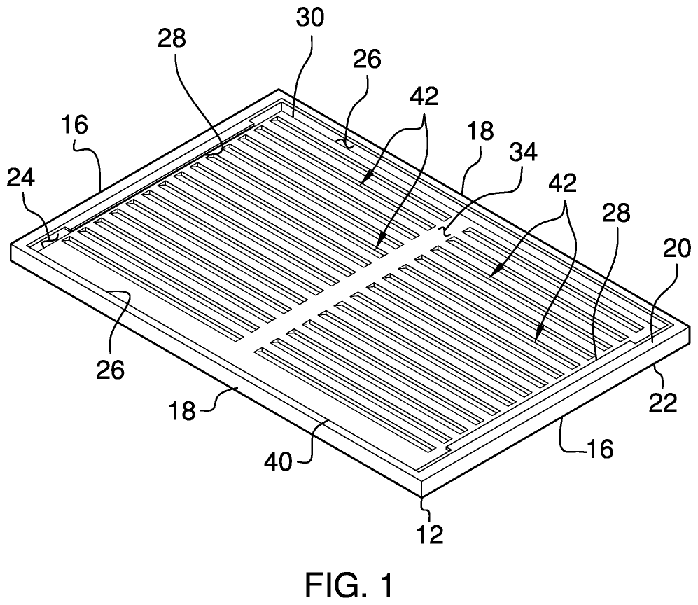

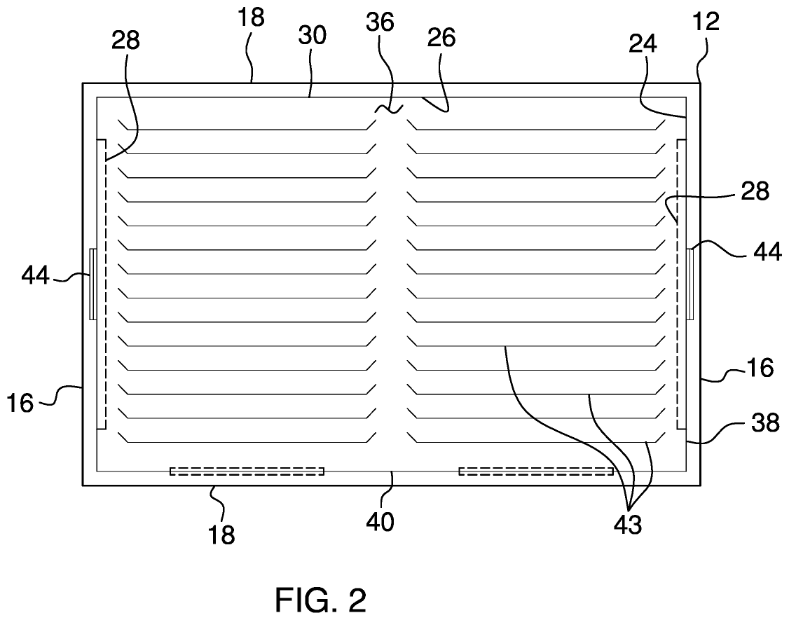

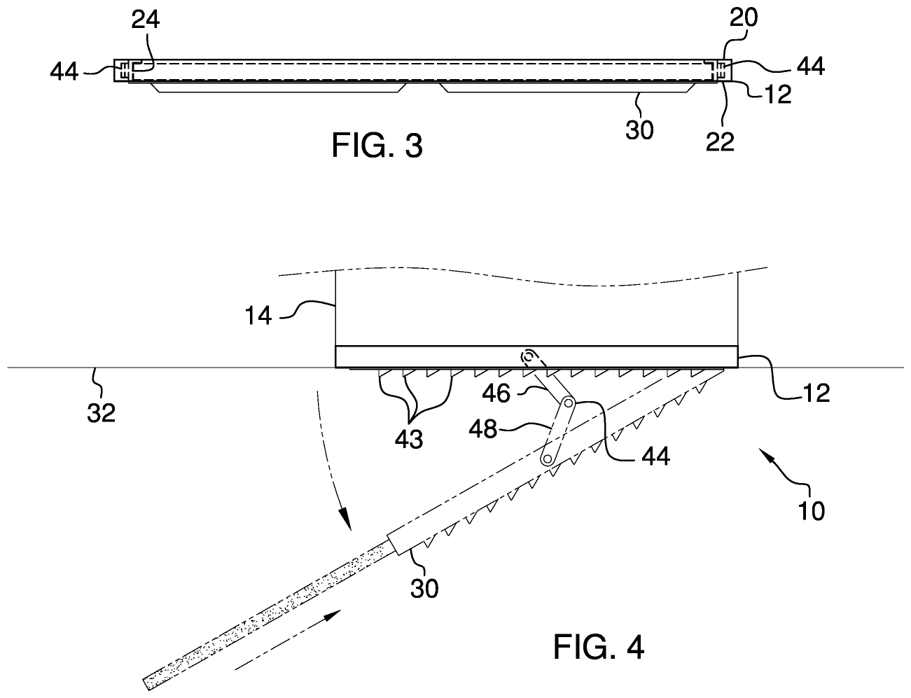

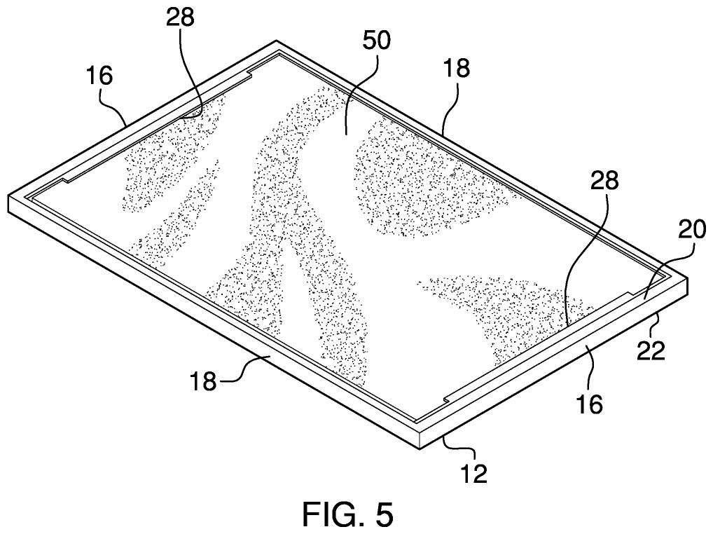

With reference now to the drawings, and in particular to FIGS. 1 through 5 thereof, a new filter device embodying the principles and concepts of an embodiment of the disclosure and generally designated by the reference numeral 10 will be described.

As best illustrated in FIGS. 1 through 5, the HVAC filter frame assembly 30 10 generally comprises a frame 12 that is positioned in a return air duct 14 of an HVAC system. The frame 12 has a pair of first members 16 that each extend between a pair of second members 18. The first members 16 are spaced apart from each other such that the frame 12 has a rectangular shape. Each of the first members 16 has a front side 20, a back side 22 and an inwardly facing surface 24 extending therebetween, and each of the second members 18 has an inwardly facing surface 26. A pair of rails 28 is each coupled to the frame 12 and each of the rails 28 is positioned on the inwardly facing surface 24 of a respective one of the first members 16. Additionally, each of the rails 28 is aligned with the front side 20 of the respective first member 16.

A vent 30 is provided and the vent 30 is hingedly coupled to the frame 12. The vent 30 is positionable in an open position having the vent 30 swinging away from the frame 12. Additionally, the vent 30 is positionable in a closed position having the vent 30 being recessed in the frame 12. Thus, the vent 30 is aligned with a surface 32, such as a wall, ceiling or the like, in which the frame 12 is positioned. The vent 30 has a forward surface 34, a rearward surface 36 and a peripheral surface 38 extending therebetween, and the peripheral surface 38 has a lower side 40. The lower side 40 is hingedly coupled to the inwardly facing surface 24 of a respective one of the second members 18 of the frame 12. Moreover, the vent 30 has a plurality of slots 42 each extending through the forward 34 and rearward 36 surfaces for passing air therethrough. The forward surface 34 of the vent 30 may have a plurality of louvers 43 thereon for directing air flowing through the slots 42.

A pair of supports 44 is included and each of the supports 44 is hingedly coupled between the frame 12 and the vent 30. Each of the supports 44 restricts motion of the vent 30 when the vent 30 is opened to retain the vent 30 at a maximum angle with the frame 12. Each of the supports 44 has a first portion 46 that is pivotally coupled to a second portion 48. The first portion 46 of each of the supports 44 is pivotally coupled to the inwardly facing surface 24 of a respective one of the first members 16 of the frame 12. Moreover, the second portion 48 of each of the supports 44 is pivotally coupled to the peripheral surface 38 of the vent 30.

A filter 50 is positionable between the vent 30 and the rails 28 for filter 50ing air passing through the vent 30 and into the return air duct 14. The filter 50 may be an HVAC filter of any conventional size and design. The filter 50 is removable when the vent 30 is positioned in the open position. Additionally, each of the supports 44 ranges motion of the vent 30 thereby inhibiting the filter 50 from falling outwardly from the return air duct 14 when the vent 30 is opened. In this way the supports 44 inhibit the filter 50 from striking a user when the filter 50 is being changed.

In use, the frame 12 is mounted into the return air duct 14 with any selected means, such as screws, adhesive or any other type of coupling. Thus, the vent 30 is aligned with the surface 32, such as a wall or ceiling, through which the return air duct 14 extends. The vent 30 is positioned in the open position and the filter 50 is slid onto the vent 30. The vent 30 is urged into the closed position and the filter 50 is retained between the vent 30 and the rails 28. In this way the filter 50 is inhibited from displacing when the vent 30 is closed. Additionally, the vent 30 is opened to replace the filter 50 and the supports 44 retain the vent 30 at the maximum angle thereby inhibiting the filter 50 from falling out of the vent 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An HVAC filter frame assembly being positionable in an open position for removing and replacing an HVAC filter, said assembly comprising:
a frame being positioned in a return air duct of an HVAC system;
a pair of rails, each of said rails being coupled to said frame;
a vent being hingedly coupled to said frame, said vent being positionable in an open position having said vent swinging away from said frame, said vent being positionable in a closed position having said vent being recessed in said frame;
a pair of supports, each of said supports being hingedly coupled between said frame and said vent, each of said supports restricting motion of said vent when said vent is opened to retain said vent at a maximum angle with said frame; and
a filter being positionable between said vent and said rails for filtering air passing through said vent and into the said return air duct, said filter being removable when said vent is positioned in said open position, each of said supports ranging motion of said vent thereby inhibiting said filter from falling outwardly from said return air duct when said vent is opened wherein said supports are configured to inhibit said filter from striking a user when said filter is being changed.

2. The assembly according to claim 1, wherein:
said frame has a pair of first members each extending between a pair of second members, said first members being spaced apart from each other such that said frame has a rectangular shape, each of said first members having an front side, a back side and an inwardly facing surface extending therebetween, each of said second members having an inwardly facing surface; and
each of said rails is positioned on said inwardly facing surface of a respective one of said first members, each of said rails being aligned with said front side of said respective first member.

3. The assembly according to claim 1, wherein:
said frame includes a pair of first members and a pair of second members, each of said first and second members having an inwardly facing surface;
said vent has a forward surface, a rearward surface and a peripheral surface extending therebetween, said peripheral surface having a lower side, said lower side being hingedly coupled to said inwardly facing surface of a respective one of said second members of said frame, said vent having a plurality of slots each extending through said forward and rearward surfaces for passing air therethrough; and
each of said supports has a first portion being pivotally coupled to a second portion, said first portion of each of said supports being pivotally coupled to said inwardly facing surface of a respective one of said first members of said frame, said second portion of each of said supports being pivotally coupled to said peripheral surface of said vent.

4. An HVAC filter frame assembly being positionable in an open position for removing and replacing an HVAC filter, said assembly comprising:
a frame being positioned in a return air duct of an HVAC system, said frame having a pair of first members each extending between a pair of second members, said first members being spaced apart from each other such that said frame has a rectangular shape, each of said first members having an front side, a back side and an inwardly facing surface extending therebetween, each of said second members having an inwardly facing surface;
a pair of rails, each of said rails being coupled to said frame, each of said rails being positioned on said inwardly facing surface of a respective one of said first members, each of said rails being aligned with said front side of said respective first member;
a vent being hingedly coupled to said frame, said vent being positionable in an open position having said vent swinging away from said frame, said vent being positionable in a closed position having said vent being recessed in said frame, said vent having a forward surface, a rearward surface and a peripheral surface extending therebetween, said peripheral surface having a lower side, said lower side being hingedly coupled to said inwardly facing surface of a respective one of said second members of said frame, said vent having a plurality of slots each extending through said forward and rearward surfaces for passing air therethrough;
a pair of supports, each of said supports being hingedly coupled between said frame and said vent, each of said supports restricting motion of said vent when said vent is opened to retain said vent at a maximum angle with said frame, each of said supports having a first portion being pivotally coupled to a second portion, said first portion of each of said supports being pivotally coupled to said inwardly facing surface of a respective one of said first members of said frame, said second portion of each of said supports being pivotally coupled to said peripheral surface of said vent; and
a filter being positionable between said vent and said rails for filtering air passing through said vent and into the said return air duct, said filter being removable when said vent is positioned in said open position, each of said supports ranging motion of said vent thereby inhibiting said filter from falling outwardly from said return air duct when said vent is opened wherein said supports are configured to inhibit said filter from striking a user when said filter is being changed.
